(19) United States
(12) Patent Application Publication
(10) Pub. No.: US 2025/0008868 A1
(43) Pub. Date: Jan. 9, 2025

(54) VALVED DOSING SYSTEM

(71) Applicant: SEEGROW HOLDINGS LIMITED, Worcester,Worcestershire (GB)

(72) Inventor: Stephen JR NOEL, Hampshire (GB)

(21) Appl. No.: 18/709,328

(22) PCT Filed: Nov. 11, 2022
(86) PCT No.: PCT/GB2022/052868

§ 371 Date: May 10, 2024

(30) Foreign Application Priority Data
Nov. 11, 2021 (GB) 2116272.2

(51) Int. Cl. A01C 23/00; A01C 23/02

(52) U.S. Cl. CPC A01C 23/007; A01C 23/026

(57) ABSTRACT

The apparatus, method and system for delivering a metered amount of a liquid composition to the ground comprises at least one penetrating element comprising a tip at a first end region of the penetrating element for penetrating ground, at least one fluid inlet aperture at a further end region of the penetrating element opposite the first end region, at least one fluid outlet aperture and an internal fluid communication passageway extending between the fluid inlet aperture and the fluid outlet aperture; and at least one valve secured to or integrally formed with or comprising said at least one penetrating element, the valve further comprising: comprising at least one valve element moveable within a body of the valve to selectively open a fluid flow path between at least one fluid inlet opening of the valve and the fluid outlet aperture.

### FIELD OF THE INVENTION

The invention relates to apparatus and methods for delivering a metered amount of a liquid composition (e.g., ozonated water and/or dissolved oxygen) to the ground. In certain embodiments, the apparatus comprises at least one penetrating element (e.g., tine) wherein at least one valve is secured to or integrally formed with the penetrating element to selectively open a fluid flow path between at least one fluid inlet opening of the valve and a fluid outlet aperture of the penetrating element.

### BACKGROUND TO THE INVENTION

The turf grass industry is a multi-billion pound a year business and is one of the fastest growing segments of horticulture. Preventing turf grass diseases is vital in providing a high-quality performance of the playing surface. Millions are spent on fungicides and other pathogen control methods to implement and manage disease control.

Sports playing surfaces such as artificial, natural grassed or hybrid playing surfaces may suffer from infestations of pathogens. Agricultural crops and fields may also suffer from soil pests leading to plant disease. For example, parasitic nematodes such as root knot nematodes (Meloidogyne) are sedentary parasites and may establish long-term infections within roots that are often damaging to commercial turf grasses or crops such as potato.

Crop damage by pathogens such as nematodes is c$174bn cost world-wide in agriculture. Synthetic pesticides and other chemicals may be used to combat soil pests or other pathogens. However, such chemicals may be toxic and cause substantial environmental damage. Increasingly, the use of such chemicals is restricted in the amounts and locations where they can be used.

A further major issue across horticulture is the ability to deliver liquid chemicals into soil in a controlled manner. The uptake of such compositions by plants through their roots may allow the plant to remain healthy and to combat disease. However, current methods largely involve products being sprayed onto the soil and relying on these products soaking into the rootzone.

In addition, the aeration of soil is one of the primary conditions for plant and crop development. Various soil aeration methods and tools have been developed to help maintain the correct air exchange in the subsurface of soil and provide oxygen to the root zone. For example, aeration can be carried out by techniques such as spiking, plugging and air injection. However, no equipment is commercially available that allows liquid compositions to be directly injected into soil in a controlled manner.

There remains a need to reduce the amount of liquid fertilisers, pesticides or other chemicals being applied to fields and/or crops.

There remains a need to develop non-toxic methods of controlling pathogens whilst maintaining beneficial bacteria in the soil.

It is an aim of certain embodiments of the present invention to at least partially mitigate the problems associated with the prior art.

It is an aim of certain embodiments of the present invention to treat and/or prevent pathogens in soil or ground.

It is an aim of certain embodiments of the present invention to provide apparatus for delivering ozonated water and/or dissolved oxygen to soil or ground.

It is an aim of certain embodiments of the present invention to provide a method of injecting ozonated water and/or dissolved oxygen into ground to treat pathogens.

It is an aim of certain embodiments of the present invention to provide a system for injecting ozonated water and/or dissolved oxygen into ground.

### SUMMARY OF CERTAIN EMBODIMENTS OF THE INVENTION

The invention relates to apparatus for delivering a metered amount of a liquid composition to the ground. Advantageously, the apparatus of the invention is capable of both aerating the soil and delivering any liquid composition in a controlled manner into the soil.

In certain embodiments, the invention relates to the development of a valved dosing system capable of direct injection of any liquid in a controlled manner into the soil. Advantageously, the valves are secured to or integrally formed with a penetrating element (e.g., tine) which is used to deliver the liquid directly into the ground. Optionally said valve includes the penetrating element, such that the valve and penetrating element are one body. Such a valve arrangement enables the consistent delivery of a pre-determined amount of liquid into the ground. Any alternative arrangements where the valves or manifold of the fluid delivery system are provided, for example, distally to the tines may lead to inconsistent fluid delivery and/or not allow the safe delivery of liquids over the larger distance between the valves and tines.

In certain embodiments, the invention relates to apparatus for delivering ozonated water and/or dissolved oxygen (optionally in combination with additional liquids) in a metered amount into the ground.

Ozone is highly reactive with many organic compounds. The effectiveness of ozone (aqueous and gaseous) has been developed as an alternative sanitizing technology to common conventional disinfectants in reducing the microbial contamination of water and/or air. However, ozone is challenging to use in outdoor field settings as it degrades quickly after production. In addition, delivering ozone to where its effectiveness can be maximised is difficult.

Advantageously, the apparatus of the invention is capable of delivering ozonated water and/or dissolved oxygen (optionally in combination with additional liquids) to sites where it produces a direct oxidation reaction on the pollutants/molecules.

The invention relates, in part, to the development of methods of controlling pathogens by delivering ozone and/or dissolved oxygen to the sites of infection of crops or grassed, artificial or hybrid pitches that may be used for sport, leisure, or the like. The methods of delivery described herein enhance the recovery of the turf grass or other agricultural crops in the soil following treatment.

Certain embodiments of the present invention provide a valved dosing arrangement wherein one or more surfaces of a fluid flow path are ozone resistant. As such, one or more internal surfaces of the fluid flow path, configured to be in contact with the liquid composition (e.g., ozonated water), are resistant to damage by ozone. In preferred embodiments, the liquid composition is ozonated water. Additionally or alternatively, the liquid composition may include dissolved oxygen.

In certain embodiments, the invention relates to a valve to deliver ozonated water (“ozone”) in a controlled manner, into the soil and/or root system. In such embodiments, the ozonated water may be delivered into the ground at a rate of between about 0.001 pmm to 50 ppm via a tine delivery system as described herein.

In certain embodiments, the invention relates to a valve to deliver dissolved oxygen (“non-ozone”), in a controlled manner, into the soil and/or root system. In such embodiments, the dissolved oxygen may be delivered at a rate between about 0.001 to about 50 ppm. Said dissolved oxygen may act as a delivery/carrier system for additives such as liquid fertiliser, insect parasitic nematodes, fungicides, wetting agents, soil conditioners, flavonoids, nematicides, Biostimulants, Acelepryn and other products registered for the control of plant parasitic insects and larvae as further described herein.

In certain embodiments, the apparatus of the invention comprises ozone-resistant material. As such, it may be used to deliver ozonated water for prolonged period of time without damage from the ozone.

Certain embodiments of the present invention provide a method that treats pathogens in soil or ground by delivery of ozonated water and/or dissolved oxygen (optionally in combination with additional liquids) into soil or ground.

Certain embodiments of the present invention provide a portable system for treating pathogens in ground or soil.

Certain embodiments of the present invention provide apparatus and methods for mixing and storing ozonated water and/or water comprising dissolved oxygen.

Certain embodiments of the present invention provide apparatus for controlling a dose of fluid delivered by one or more penetrating elements (e.g., tines).

In certain embodiments, the liquid composition is ozonated water and/or the one or more surfaces of the fluid flow path are ozone resistant.

In certain embodiments, the liquid composition is water comprising dissolved oxygen.

Certain embodiments of the present invention provide delivery of ozonated water, dissolved oxygen and/or bioflavonoids into soil or ground to treat pathogens.

Certain embodiments of the present invention provide apparatus that inject ozonated and/or bioflavonoids to treat pathogens in the soil or ground.

Accordingly, the invention provides apparatus for delivering a metered amount of a liquid composition to the ground, the apparatus comprising:
at least one penetrating element, comprising:
   a tip at a first end region of the penetrating element for penetrating ground,
   at least one fluid inlet aperture at a further end region of the penetrating element opposite the first end region,
   at least one fluid outlet aperture and,
   an internal fluid communication passageway extending between the fluid inlet aperture and the fluid outlet aperture;
and;
at least one valve secured to or integrally formed with or comprising said at least one penetrating element, the valve further comprising:
   at least one valve element moveable within a body of the valve to selectively open a fluid flow path between at least one fluid inlet opening of the valve and the fluid outlet aperture.

Aptly, the at least one valve further comprises a flow regulator.

The apparatus may be used to deliver any suitable liquid. Typically, the liquid is ozonated water, dissolved oxygen and/or the one or more surfaces of the fluid flow path are ozone resistant. For example, the valve body, valve element and/or penetrating element may be manufactured from one or more ozone-resistant materials. Typically, the lower surface of a piston, the surface of a valve fluid inlet and/or outlet, the surface of a sealing member, the surface of a bore of the tine and/or the surface of an internal fluid chamber of the valve body are ozone resistant.

As described herein, an ozone-resistant material includes any material that does not degrade (or only degrades slowly) in the presence of ozone. Typically, an ozone-resistant material is a material where ozone has no effect and will last indefinitely in the presence of ozone. However, ozone resistant materials may also include materials where ozone only has a minor effect. Prolonged use with high concentrations of ozone may break down or corrode such materials, but they may still be utilised in the present invention.

In preferred embodiments, the ozone-resistant material comprises any one or more of Santoprene, Silicone, Stainless steel (304/316), Titanium, Polycarbonate, Butyl, Chemraz, CPVC, Cross-Linked Polyethylene (PEX), Durachlor-51, EPR, Ethylene-Propylene, Fluorosilicone, Glass, Hastelloy-C®, HDPE, Inconel, Kalrez, Kel-FR (PCTFE), PEEK, Polycarbonate, Polyurethane, PTFE, PVC, PVDF (Kynar®), Santoprene, Silicone, Vamac, Viton or the like. Ozone has little to no effect on these materials, and embodiments of the present invention manufactured from these materials should last indefinitely in the presence of ozone.

In certain embodiments the ozone-resistant material comprises any one or more of EPDM, ABS plastic, Acrylic (Perspex®), Brass, Bronze, Copper, Flexelene, LDPE, Polyacrylate, Polyethelyne, Polysulfide, 316 Stainless Steel, Stainless Steel (other grades), Tygon, Aluminium or the like. Ozone only has minor effect on these materials.

In certain embodiments, the valve(s) are secured proximate to the penetrating element(s). In other words, the valve(s) may be secured adjacent or immediately adjacent to the penetrating element(s). Advantageously, this allows the fine control of liquids (e.g., ozonated water and/or dissolved oxygen) being delivered into the ground via the penetrating element(s). Optionally, the valve may comprise the penetrating element, such that the valve and tine form a single valve tine body.

Any suitable valve may be used. In certain embodiments, the valve further comprises at least one actuating element comprising at least one pilot and/or at least one solenoid. Typically, the solenoid is adapted to move the valve element between a closed position and an open position. The valve may comprise an actuation time in the range, for example, of at least about 20 to 200 ms, about 200 to 500 ms or about 0.5 to 1 s or the like. The valve may also include a flow regulator for fine control of doses. The flow regulator may be mechanical or electronic.

In certain embodiments, a changeover from ozonated water to dissolved oxygen (or vice versa) may be done via software or electrical switching. In such embodiments, a metered amount of ozonated water may be delivered to the ground before switching to the delivery of dissolved oxygen to the ground. Alternatively, a metered amount of dissolved oxygen may be delivered to the ground before switching to the delivery of ozonated water.

In certain embodiments, ozonated water and dissolved oxygen are delivered simultaneously to the ground.

In certain embodiments, the penetrating element comprises a plurality of substantially parallel tine elements. As used herein, a “tine” may be hollow defining an internal passage therein with one or more outlet apertures. The tines may be used to deliver the composition of the invention to any suitable depth of soil. Typically, the tines deliver the composition of the invention to a soil depth of about 400 to about 500 mm (e.g., 450 mm).

In certain embodiments, each tine element may be secured proximate to, or integrally formed with, a valve. Alternatively, the valve and tine element may be formed in a single valve tine body. Typically, two or more tine elements are secured proximate to, or integrally formed with a valve. The plurality of tine elements may comprise two substantially parallel tine elements spaced apart, for example, by a distance of between about 25 to about 160 mm.

In certain embodiments, the apparatus further comprises at least one connector member that secures the further end of the penetrating element to the valve. For example, the connector member may be a common connector member securing each of the plurality of tine elements to at least one respective valve. The connector member may be a common connector member securing each of two tine elements to a respective valve. The connector member may secure a distal end of a tine element to an outlet member of the valve. For example, the end of the tine element and the outlet member may be secured in a sealing engagement or in any other suitable way.

In certain embodiments, the apparatus further comprises a connecting arm comprising an elongate arm element secured to the connector member at a first end of the arm element and to a ring-shaped element at a further end of the arm element, the ring-shaped element being connectable to a crank, wherein the connecting arm extends away from the connector member in a direction substantially opposite to the tine element.

In certain embodiments, each tine element comprises at least one fluid outlet aperture disposed on at least one side wall extending between a tip end and a distal end of each tine element. For example, each tine element may comprise two fluid outlet apertures disposed at opposing locations on the side wall. Typically, at least one side wall is an annular side wall.

In certain embodiments, the tine fluid outlet is spaced a distance of about 1 millimetre to about 50 millimetres from the tip of the tine element.

In certain embodiments, a diameter of tine fluid outlet is in the range of about 4 mm to about 25 mm.

In certain embodiments, a diameter of the internal fluid communication passageway is in the range of about 2.5 to about 23 mm.

In certain embodiments, the fluid flow path is selectively opened, a metered amount of ozonated water in the range of about 2-100 gallons per hour is capable of flowing through the penetrating element (e.g., tine) fluid outlet.

In certain embodiments, the tine fluid inlet and valve fluid outlet are separated by a distance of up to about 4 to about 25 mm.

The invention also provides a ground injection system for delivering a metered amount of a liquid composition to the ground, the system comprising:
a frame;
at least one crank assembly attached to the frame, the crank assembly or assemblies comprising at least one crank attached to a rotatable crankshaft drivable by a motor;
at least one tine assembly, comprising the apparatus as described herein, each attached to at least one crank of the crank assembly such that the tip of a penetrating element points towards the ground; and
at least one fluid delivery conduit for delivering the liquid composition to a valve of a respective tine assembly.

In certain embodiments, the liquid composition used in the system of the invention is ozonated water and/or comprises dissolved oxygen.

In certain embodiments, a portion of the fluid delivery conduit that defines a fluid flow path through the conduit is manufactured from one or more ozone-resistant materials. Any suitable ozone-resistant material may be used, as further described herein.

In certain embodiments, the tine assembly is reciprocally moveable by the crank in a direction substantially parallel to a central longitudinal axis of the tine elements.

In certain embodiments, the system further comprises a holding vessel that stores a liquid (e.g., ozonated water and/or comprising dissolved oxygen) and that is connected to the fluid delivery conduit.

In certain embodiments, the system further comprises:
an ozone generator that is adapted to generate gaseous ozone; and
a further fluid delivery conduit adapted to deliver the gaseous ozone to the holding vessel for ozonating water.

In certain embodiments, the system further comprises a source of compressed air in fluid communication with the holding vessel, the compressed air being selectively providable to the ozonated water at predefined intervals to agitate the ozonated water and/or provide dissolved oxygen to the water.

In certain embodiments, each tine assembly is attached to a respective crank.

In certain embodiments, each tine assembly is attached to a crank via a pivot arm.

In certain embodiments, the system further comprises a plurality of tine assemblies and a plurality of crank assemblies, each crank assembly comprising two cranks sharing a common rotatable crankshaft, and each crank attached to a respective tine assembly.

In certain embodiments, the system further comprises at least one link arm attached to the frame and a respective tine assembly adapted to maintain reciprocal movement of the tine assembly in a direction substantially parallel to a central longitudinal axis of the tine element.

In certain embodiments, the system further comprises at least one support element attached to the frame for supporting the frame thereby enabling the frame to be moved across ground.

In certain embodiments, each rotatable crankshaft is drivable by a common motor.

In certain embodiments, the system further comprises a tow bar attached to the frame connectable to a vehicle for moving the ground injection system across ground.

Any suitable vehicle may be used. Typically, the vehicle is a tractor or the like.

In certain embodiments, the system is portable.

In certain embodiments, the system further comprises at least one programmable logic controller configured to control operation of a solenoid in the valve assembly adapted to move the valve member between its open and closed positions.

In certain embodiments, the invention provides a method of delivering a metered amount of a liquid composition to the ground, the method comprising:
providing at least one penetrating element comprising a tip at a first end for penetrating the ground and at least one fluid outlet aperture;
inserting the penetrating element into ground; and
when the penetrating element is in the ground, selectively opening a fluid flow path between a fluid inlet of at least one valve and the fluid outlet aperture, thereby delivering a metered amount of the liquid composition to the ground.

In certain embodiments, the method further comprises:
providing the at least one valve secured to or integrally formed with or comprising the penetrating element; and/or
providing the liquid composition to at least one fluid inlet of the valve; and/or
rotating a crankshaft to cause reciprocal movement of at least one crank attached to the crankshaft such that the penetrating element that is attached to the crank repeatedly enters and withdraws from the ground; and
each time the penetrating element is in the ground, selectively opening a fluid flow path between the fluid inlet of the valve and the fluid outlet aperture of the penetrating element, thereby delivering a metered amount of the liquid composition to the ground.

In certain embodiments, the liquid composition used in the method of the invention is ozonated water and/or comprises dissolved oxygen.

In certain embodiments, the method further comprises:
providing an ozone generator adapted to generate gaseous ozone; and
providing gaseous ozone to a holding vessel for ozonating water stored in the holding vessel.

In certain embodiments, the ozonated water and/or dissolved oxygen is provided to at least one valve fluid inlet via at least one ozonated water and/or dissolved oxygen delivery conduit.

In certain embodiments, a metered amount of the liquid (e.g., ozonated water) is delivered into the soil of a grassed, artificial or hybrid pitch. For example, ozone alone may be applied to any turf for playing sport, for recreation and/or for ornamental purposes. Typically, the turf can be used as a field for playing sport such as football (soccer), tennis, hockey, American football, golf, athletics, rugby, baseball or any other sport that can be played on turf grass. Typically, the golf turf is USGA standard.

As described herein, artificial turf typically comprises a dense cover of polymeric fibres of a defined length on which a filler material consisting of sand or rubber or the like of specified granulometry is distributed.

As described herein, a hybrid pitch surface typically comprises a combined system of mixed natural and artificial turf.

In certain embodiments, the method is a method of delivering a metered amount of liquid (e.g., ozonated water and/or dissolved oxygen) into the soil of agricultural and/or horticultural field. The field may be used to grow any type of crop. Exemplary crops include, but are not limited to, alfalfa, banana, beans (e.g., soybean), peas, cereals (e.g., barley, wheat, rye), chickpea, citrus, clover, corn, cotton, grapes, grasses, peanut, potato, rice, small fruits, soybean, sugar beet, sugar cane, tobacco, tomato, cucumber, pepper, carrots, rapeseed (canola), sunflower, safflower, sorghum, strawberry, banana, turf, ornamental plants or the like.

In certain embodiments, the ozonated water comprises ozonated water and one or more additional liquids (e.g., flavonoids or the like) as further described herein. In addition, or alternatively, the liquid composition may comprise dissolved oxygen.

Embodiments of the present invention will now be described hereinafter, by way of example only, with reference to the accompanying drawings in which:

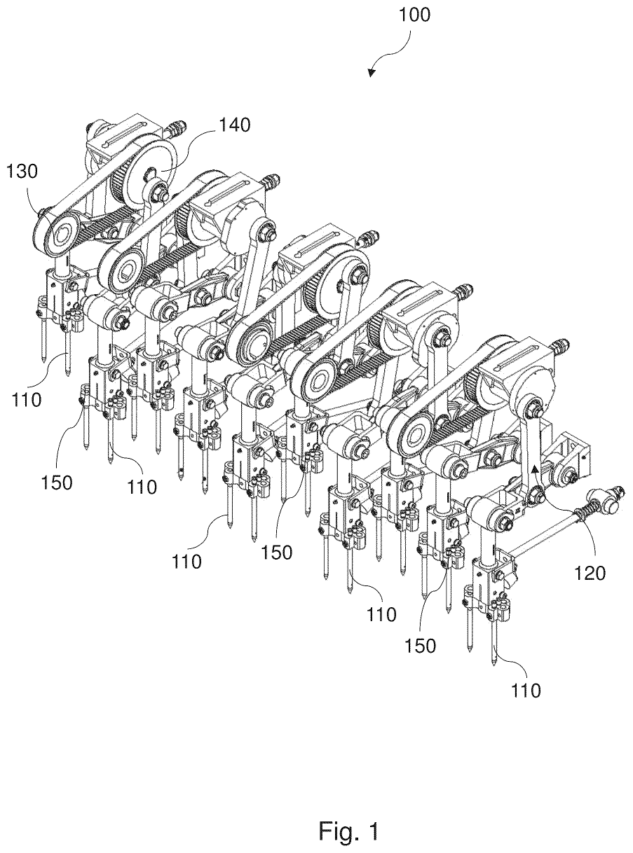

FIG. 1 illustrates a portion of a tine-based liquid composition delivery system of the present invention.

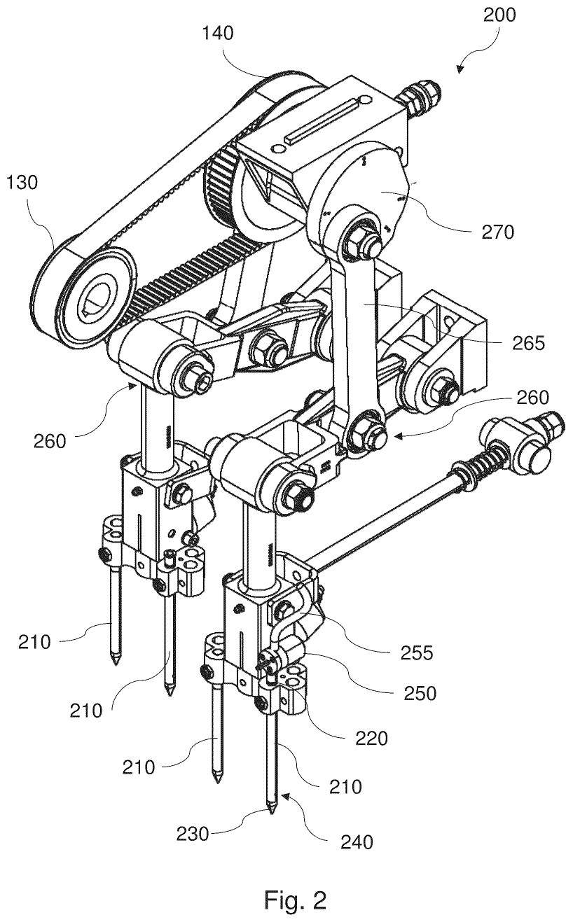

FIG. 2 illustrates a magnified view of the portion of the tine-based liquid composition delivery system of the present invention.

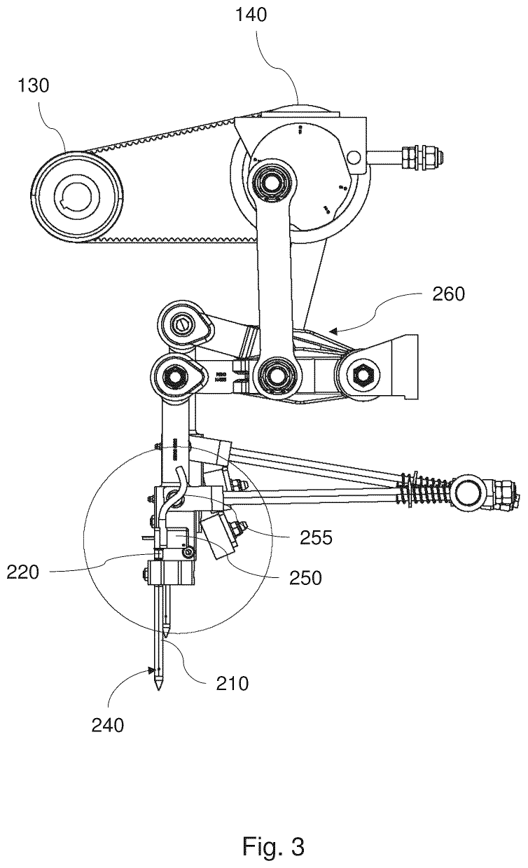

FIG. 3 illustrates a side view of the portion of the tine-based liquid composition delivery system of the present invention.

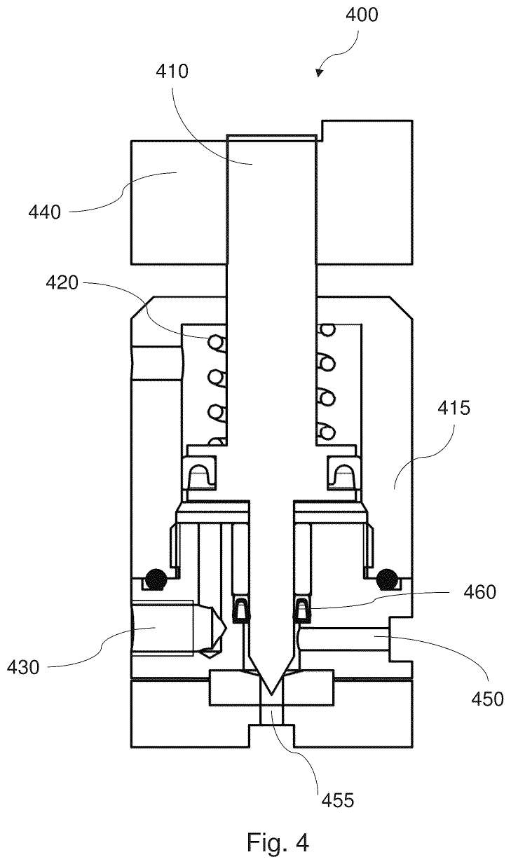

FIG. 4 illustrates a cross-sectional view of a valve of the present invention.

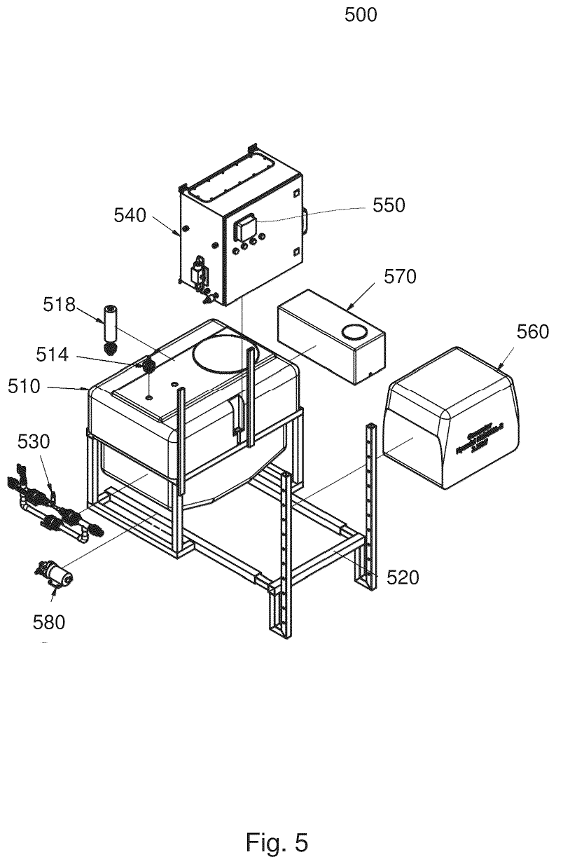

FIG. 5 illustrates an ozonated water generation and delivery system of the present invention.

In the drawings like reference numerals refer to like parts.

### DETAILED DESCRIPTION

### Liquid Compositions

The apparatus, system and methods described herein can be used to deliver any liquid composition.

Any suitable amount of the liquid composition may be delivered to the ground. The amount of liquid to be applied to a site of infection may depend, for example, on the overall area to be treated (e.g., number of hectares), the type of pathogen to be treated (e.g., parasitic nematodes or other pathogens) and particular site of infection (e.g., sports playing surface or type of agricultural crop).

In certain embodiments, the liquid composition comprises one or more pathogen reducing compounds. For example, the compound may have insecticide, fungicide, nematicide, bactericide and/or anti-viral properties.

Typically, the liquid composition is a naturally occurring compound. Typically, the liquid composition is highly effective in the control of a large number of pests and pathogens as described herein. Typically, the liquid composition is present within a composition that boost's a plants' own defence system and/or alleviates the symptoms of stress and damage caused by an attack. Typically, the liquid composition is within a composition that is not designed to kill the pests but to deter and discourage them from attacking the plant.

In certain embodiments, the liquid composition is a natural nematicide. For example, the nematicide may be a garlic-derived polysulfide, neem-extract, root exudate of marigold (Tagetes) or carnivorous fungi (e.g., nematophagous fungi) or the like.

In certain embodiments, the liquid composition is an antioxidant. Such compounds act to inhibit oxidation, a chemical reaction that can produce free radicals and chain reactions that may damage the cells within turf grasses or other agricultural crops. For example, the antioxidant may comprise one or more ascorbates, tocopherols, reduced glutathione and its derivatives, cysteines (half cystines) or the like.

### Ozonated Water

In preferred embodiments, the liquid composition is ozonated water. In addition or alternatively, the water may comprise dissolved oxygen as further described herein.

Ozone (or trioxygen) is an inorganic molecule with the chemical formula O₃. Ozone is a powerful oxidant, rendering it useful as a sterilizing and/or preserving agent in either aqueous or gas phase. For example, ozone is a powerful disinfectant commonly available for food sanitizing and water treatment.

Preferably, the ozonated water comprises both gaseous ozone (O₃) and oxygen (O₂). Typically, the oxygen has a stabilised pH (e.g., using CO₂ gas).

In certain embodiments, the ozonated water comprises one or more acids. For example, citric acid or CO₂ may be used to lower pH and maintain ozone in the water for an increased duration of time.

The ozonated water may be obtained in any suitable way. A wide variety of different systems for producing ozone are commercially available.

Due to its tendency to break down quickly, ozone cannot be easily stored or transported. Typically, ozone is generated on site by ozone generators (also called “ozonators”). Ozone is most commonly produced by the passage of dry, ambient air or pure oxygen either past a source of ultraviolet light or through an electrical discharge (e.g., corona discharge). The ozone is then injected or diffused into the treatment stream.

Typically, the ozone is prepared on-site using a system comprising an ozone generator within about 60 minutes, 45 minutes, 40 minutes, 30 minutes or less of applying the ozone to the site of infection. Such systems are also further described herein.

Where corona discharge is used to produce ozone, two electrodes may be separated by a dielectric and gas-filled gap. AC voltage may then be applied to the cell. The electrical discharge in the gas-filled gap creates free, energetic electrons that dissociate O₂ molecules into oxygen (O) atoms. These oxygen atoms are intermediates that then form ozone.

Portable ozone generators are commercially available. Typically, the generator is adapted to accommodate the ozone levels required for any particular application. For example, software can be used to program the ozone generator depending, for example, on the amount of ozone for injection required.

As ozone can be decomposed by heating, temperature control of the process gas and heat removal are important factors in ozone generator efficiency. Typically, an array of water-cooled tubular cells is used. Typically, the generating capacity of an ozone generator is increased by enriching the air with oxygen.

Typically, the ozone generator produces a gaseous stream comprising a high concentration of ozone from oxygen, an oxygen-enriched gaseous stream, or air. Typically, the ozone generator is self-contained and/or portable. Preferably, a corona discharge ozone maker is used as this is currently the most efficient method of producing ozone.

Typically, the system for producing ozone comprises a holding vessel comprising water. For example, the system may comprise means for inputting the gaseous ozone to the holding vessel to produce ozonated water.

In certain embodiments, an oxygen-enriched gaseous stream is produced using an oxygen concentrator assembly. The ozone from oxygen, an oxygen-enriched gaseous stream or air may be introduced into a water stream or flow by any suitable means. For example, a venturi injector or any other suitable injection assembly may be used (e.g., nano bubble method or the like). A venturi injector may provide a source of suction which urges the ozone-containing gaseous stream from the ozone generator into the water stream or flow. The water may be passed through the venturi injector only once prior to dispensing the ozonated water onto the site of infection through an outlet assembly connected to the fluid passageway.

Prior to dispensing the ozonated water onto the site of infection, the ozonated water may be mixed or combined with one or more additional compounds such as those further described herein.

In certain embodiments, the ozone system includes a water tank, an oxygen generator, electric generator and ozone generator, a pump (e.g., venturi injector, nano bubble method or the like) for injecting gaseous ozone into recirculated water to form an ozone-water mixture. In addition, a pressure regulating subsystem may be provided for maintaining a consistent, regulated internal pressure of the aqueous stream as the stream is processed within the unit or system.

In certain embodiments, the ozone system includes an ozone analyser for sensing the amount of dissolved ozone in the holding vessel. Such an analyser may also be used to hold the dissolved ozone level at a constant level.

In certain embodiments, the ozone system includes a top access port. This may be configured to allow any undissolved ozone and oxygen to exit the water tank. Typically, the access port is connected to an ozone destruct unit which will remove ozone making the air exiting the system safe.

Any suitable amount of dissolved ozone and/or oxygen may be used in the holding vessel. The amount of dissolved ozone and/or oxygen to include in the system may depend on the flow rate used to deliver the ozonated water and/or dissolved oxygen (e.g., litres per hectare) and/or the ultimate dosage of ozone (ppm) and/or dissolved oxygen (ppm) to be applied to the site of infection. Typically, for example, the generator is adapted to generate ozone and/or dissolved oxygen in quantities of between about 2 to 100 g per hour.

The skilled person will understand that flow rates and/or dosage of ozone to apply to the site of infection may be optimized depending, for example, on the overall area to be treated (e.g., number of hectares), the type of pathogen to be treated (e.g., parasitic nematodes or the like) and particular site of infection (e.g., sports playing surface or type of agricultural crop).

In certain embodiments, the system may dispense ozonated water and/or dissolved oxygen at a flow rate of about 350, 400, 450, 500, 550, 600 litres or more per hectare. Typically, a flow rate of about 350 litres per hectare is used to dispense ozonated water and/or dissolved oxygen, for example, to treat grassed playing surfaces (e.g., professional football pitches, USGA golf pitches or the like). However, lower flow rates may be used to treat smaller pitches.

In certain embodiments, the ozonated and/or dissolved oxygen water stream has an ozone and/or dissolved oxygen concentration of at least about 0.001 ppm, about 0.1 ppm, about 0.2 ppm, about 0.3 ppm, about 0.4 ppm, about 0.5 ppm, about 1 ppm, about 2 ppm, about 4 ppm, about 5 ppm, about 6 ppm, about 8 ppm, about 10 ppm, about 20 ppm, about 30 ppm, about 40 ppm, about 50 ppm or more. For example, the ozonated water and/or dissolved oxygen may preferably comprise at least about 10 ppm ozone and/or dissolved oxygen.

In preferred embodiments, the ozonated water and/or dissolved oxygen comprises about 0.001 ppm to about 50 ppm. The skilled person would understand the dosage of ozonated water and/or dissolved oxygen may depend on the type (and/or numbers) of pathogen to be treated, the size and/or type of pitch to be treated, or the like.

In preferred embodiments, the system further comprises means of combining the ozone with one or more additional compounds (e.g., other liquids) as further described herein.

### Flavonoids or Other Additives

In certain embodiments, the liquid composition comprises a liquid fertiliser, fungicide, wetting agent, soil conditioner, flavonoid(s), nematicide, biostimulant, insecticide (e.g., Acelepryn) or any other product registered for the control of plant parasitic insects and larvae.

In certain embodiments, the liquid composition comprises ozonated water and/or dissolved oxygen in combination with one or more of a liquid fertiliser, fungicide, wetting agent, soil conditioner, flavonoid(s), nematicide, biostimulant, insecticide (e.g., Acelepryn) or any other product registered for the control of plant parasitic insects and larvae.

In certain embodiments, the liquid composition comprises flavonoids in combination with ozonated water and/or dissolved oxygen.

In certain embodiments, the flavonoids are in a liquid composition further comprising cold pressed seaweed. Typically, the composition may comprise about 25% plant flavonoids and about 75% cold pressed seaweed.

Typically, the flavonoids are particularly effective against pathogens. By way of non-limiting example, the flavonoids may be particularly effective against parasitic nematodes or any other pathogens such as bacteria, fungi, virus or the like.

Flavonoids are phenolic compounds having the general structure of two aromatic rings connected by a three-carbon bridge. Flavonoids are produced by plants and have many functions, for example as beneficial signalling molecules and as protective agents against pathogens.

As used herein, the term “flavonoid” includes any flavonoid compound, isomer or salt thereof. The one or more flavonoids may be natural flavonoids, synthetic flavonoid or any combination thereof.

The flavonoids of the composition may be obtained in any suitable way. The flavonoids can be isolated from any suitable plant or seeds. Typically, the flavonoids are obtained from citrus or citrus waste (e.g., orange or peel) using techniques already described in the art (see, especially, “processing of citrus peel for the extraction of flavonoids for biotechnological applications”, in book: Flavonoids: Dietary sources, Properties and health Benefits (p 443-459).

In certain embodiments, the flavonoids are extracted by solvent extraction (Xu et al., Journal of Agricultural and Food Chemistry (2007, 55 330-335); Zia-ur-Rehman, Food Chemistry (2006, 99:450-454); Anagnostopoulou et al., Food Chemistry (2006, 94 19-25); Li et al., Separation and Purification Technology (2006, 48:182-188); Jeong et al., Journal of Agricultural and Food Chemistry (2004, 52 3389-3393); Manthey and Grohmann, Journal of Agricultural and Food Chemistry (1996, 44 811-814), hot water extraction (Xu et al., 2007), alkaline extraction (Bocco et al., Journal of Agricultural and Food Chemistry (1998, 46 2123-2129; Curto et al., Bioresource Technology (1992, 42 83-87), resin-based extraction (Kim et al., Journal of Food Engineering (2007, 78 27-32); Calvarano et al., Perfumer and Flavorist (1996, 21 1-4), electron beam- and γ-irradiation-based extractions (Kim et al., Radiation Physics and Chemistry 2008, 77 87-91), supercritical fluid extraction (Giannuzzo et al., Phytochemical Analysis (2003, 14 221-223) or enzyme-assisted extraction (Puri et al., International Journal of Biological Macromolecules (2011, 48 58-62); Li et al., Separation and Purification Technology 2006, 48 189-196).

In alternative embodiments, the flavonoids are produced by genetically engineered organisms (e.g., yeast) as described, for example, in Roston et al, Plant Physiology (Plant Physiology) 137:1375-88 (2005).

In preferred embodiments, the flavonoid is derived from citrus. For example, the flavonoids may comprise “Flav-X” or “SGS-Activate” as commercially available from SeeGrow Solutions Limited.

In certain embodiments, the flavonoid is an anthocyanidin, flavan-3-ol, flavonol, flavanone, flavones, isoflavone or chalcone.

In certain embodiments, the anthocyanidin is cyanidin, delphinidin, malvidin, pelargonidin, peonidin or petunidin. In certain embodiments, the flavan-3-ol is a proanthocyanidin, theaflavin, thearubigin, catechin, epicatechin, epigallocatechin, gallocatechin or a derivative thereof. In certain embodiments, the flavonol is isorhamnetin, kaempferol, myricetin, fisetin or quercetin. In certain embodiments, the flavone is apigenin, luteolin, baicalein or chrysin. In certain embodiments, the flavanone is eridictyol, hesperetin or naringenin. In certain embodiments, the isoflavone is daidzein, genistein, glycitein, Biochanin A or formonetin. In certain embodiments, the chalcone is naringenin or eriodictyol.

In certain embodiments, the flavonoid is a phytoalexin, coumestrol, glyceollin which have been shown to increase resistance to, or minimize the effect of, nematode presence.

In certain embodiments, the flavonoid is a glyceollin, phaseollin, sakuranetin, isoflavonoid, peterocarpan, medicarpin, coumesterol, psoralidin, quercetagetin, flavan-3,4-diol, condensed tannin, daidzein, genistein, kaempferol, quercetin, myricetin, patuletin, E-chalcone or any combination thereof.

Any suitable amount of flavonoid may be delivered to the ground. The amount of flavonoid to be applied to a site of infection may depend, for example, on the overall area to be treated (e.g., number of hectares), the type of pathogen to be treated (e.g., parasitic nematodes or other pathogens) and particular site of infection (e.g., sports playing surface or type of agricultural crop).

In certain embodiments, the flavonoids are mixed with ozone prior to being dispensed to a site of infection. Advantageously, combining ozone with flavonoids significantly impacts pathogens such as parasitic nematodes without adversely affecting beneficial fungi or other microbes in the soil. Unexpectedly, the use of flavonoids also increases the duration in which the ozone is effective on any of the surface types as described herein and enhances the recovery of the turf grass or other agricultural crops in the soil following the ozone treatment.

Any suitable type of mixing control or vessel may be used to combine ozone with flavonoids and/or other liquids as described herein. For example, commercially available Dosatron models (Dosatron International Inc., Florida) may be used to combine flavonoids (or other liquids) with ozonated water and/or dissolved oxygen. Any other suitable type of system may also be used to regulate and/or control the concentration of flavonoids and/or other compounds as described herein.

In certain embodiments, the level of flavonoids (or other liquids) is set at a pre-determined level, and a control system (e.g., Dosatron or the like) is used to add the relevant flavonoid(s) or other compound(s) when its concentration falls below the pre-determined level.

The amount of flavonoid or other liquid used in the composition may depend on the flow rate used to deliver the ozonated water and/or flavonoids or other compounds (e.g., litres per hectare) and/or the dosage of flavonoids or other compounds (mg/l) to be applied to the site of infection.

In certain embodiments, the composition comprises at least about 0.001 ppm, about 0.1 ppm, about 0.5 ppm, about 1 ppm, about 2 ppm, about 4 ppm, about 5 ppm, about 6 ppm, about 8 ppm, about 10 ppm, about 20 ppm, about 30 ppm, about 40 ppm, about 50 ppm or more. For example, the composition may preferably comprise at least about 10 ppm flavonoids.

In certain embodiments, the system may dispense the flavonoids or other pathogen reducing compounds at a flow rate of about 1, 1.2, 1.3, 1.4, 1.5, 1.6, 1.7, 1.8, 1.9, 2.0 litres or more per hectare. Typically, a flow rate of about 2 litres per hectare is used, for example, to treat parasitic nematode infection of grassed playing surfaces as described herein.

Any suitable ratio of flavonoid:ozonated water may be used. Typically, a ratio of about 1:100, about 1:200, about 1:300, about 1:400, about 1:500, about 1:1000 flavonoids to ozonated water is used. By way of example, about 1 litre of flavonoids (e.g., FlavX which contains 3% flavonoids) may be used per 350 litres of ozonated water to treat grassed playing surfaces (e.g., professional football pitches, USGA golf pitches or the like). However, lower flow rates may be used to treat smaller pitches.

### Apparatus & Systems

FIG. 1 illustrates a portion of a tine-based liquid composition delivery system (100). A tine-based liquid composition delivery system, or tine delivery system, is but one example of an aeration tool for maintaining the correct air exchange in the ground subsurface and, as a result, provides vital oxygen to the root zone of turf grass. Aeration by spiking, for example using tines, produces the least disturbance to the surface. The system (100) includes a plurality of tines (110) or penetrating elements secured to respective linkages (120). Each tine or each pair of tines may have a respective linkage (120). Each linkage (120) may include a crank coupled to a crankshaft of the tine delivery system. As the crankshaft is rotated, this rotation is translated by each linkage into linear motion of the tines, such that each tine is able raise and lower along a respective elongate axis of the tine.

The tine delivery system (100) is typically towed behind a vehicle. As the vehicle moves over, or next to, for example, turf grass or a playing surface, such as a sports pitch, the crankshaft, coupled to one or more gears (130, 140), is driven by a motor that causes each tine (110) to move up and down along an elongate axis of the tine cyclically. This may result in the tines penetrating the ground surface to deliver fluids, followed by lifting the tine before lowering and penetrating the ground again at a new location on the surface.

In certain embodiments, liquid ground injection or aeration may take place by the tine delivery system being affixed to or drawn by a tractor with a power take off (PTO) device operating at between 450 and 500 rpm or a walk-in-front pedestrian piece of apparatus functioning the same way which can be powered by a battery cell or independent combustion engine. The tine delivery systems may comprise a single tine or multiple tines which are driven vertically reciprocating via a crankshaft that is driven from a motor. Either all the tines or every other one may have or include a pilot operated and/or electronic solenoid actuated valve attached giving control by air signal and/or by a control unit which may enable a controlled dose mix of liquid (e.g., dissolved ozonated water and/or bioflavonoid) into the ground.

FIG. 1 further shows multiple tine connection points (150) that may interface with one or more connecting tubes (not shown) to form a fluid flow path with one or more valves and/or a manifold (not shown) provided in a portion of the tine delivery system (100) separate and distinct from the tines (110). In the present invention, the valve system (not shown in FIG. 1) may be adapted such that valves are provided proximate to the tines (110) or linkages (120) as shown in FIG. 1. In certain embodiments, one or more surfaces of the fluid flow path are ozone resistant.

FIG. 2 illustrates a portion of a tine assembly (200) of the present invention. In FIG. 2, each tine (210) or penetrating element is a fine pipe or tube, of narrow diameter, having a head end (220) and a tip end (230). The tip end is tapered to a point for penetrating the ground (e.g., soil). Each tine (210) may also have one or more holes or fluid outlet apertures (240) in the tip or an outer wall of the tine. Each hole (240) or fluid outlet in the tip or outer wall of the tine may have a diameter in the range of about 6 to about 25 mm. Each hole or fluid outlet aperture may be provided in an outer wall of the tine at a distance in the range of about 1 mm to about 50 mm from the tip end of the tine. Providing the hole (240) in an outer wall of the tine decreases the risk of blocking the hole by dirt and soil, when compared to providing the hole at the tip end. Each tine (210) has an inner bore for carrying fluid at least partially along a length of the tine. The bore may extend from the head end of the tine to the tip end. The tines may vary in length.

Also secured at the head end (220) of each tine (210), or at the head (220) of one of each pair of tines (210), is a valve (250). Preferably, the valve (250) is a needle valve. Alternatively, the valve (250) may be a ball valve, gate valve, butterfly valve, check valve or pinch valve. The valve (250) may also be of a type suitable for delivering ozone or ozonated fluids. The valve (250) may also be of a type compatible with delivering bioflavonoids or any other liquid. Alternatively, the valve comprises a single valve tine body that comprises a tine or pair of tines.

The valve (250) may alternatively be secured proximate to the head end (220) of the tine (210), such that the valve is provided within a distance of about 5 mm to about 25 mm between a fluid inlet of the tine (210) and a fluid outlet of the valve (250). In an alternative embodiment, a tine or tines may be formed integrally with the valve. The valve (250) may be pneumatically, hydraulically, or electrically actuated. The valve may be controlled by a control module (not shown) that may control and synchronise the actuation of each respective valve. The valve includes a fluid inlet that is in fluid communication with a fluid source via a fluid pathway (255). The fluid pathway (255) may be a pipe or tube. The fluid pathway may be constructed from an ozone resistant material.

Each tine (210) or pair of tines form a tine assembly that is secured to a respective linkage (260), via a region of the head end (220). Where a pair of tines is secured to each linkage, the pair of tines may be spaced apart by a distance in the range of about 25 mm to about 160 mm. Each linkage (260) includes one or more cranks (265) that couple each tine or pair of tines (210) to one or more gears (130, 140). As the gears (130, 140) rotate, a cam or crankshaft (270) coupled with one or more cranks (265) is driven. The crank (265) is secured to a region of the cam (270) that is offset from the centre of the cam. This causes an eccentric rotation of the crank (265) around an axis associated with the centre of the cam (270). This eccentric motion of the crank (265) about the central axis of the cam (270) allows the crank to provide linear motion of the tines (210). The tines may be secured to each respective linkage such that an elongate axis of each tine is substantially orthogonal to the ground surface. Alternatively, the tines may be secured to each respective linkage at an angle in the range of about 45 to about 90 degrees relative to the ground surface.

FIG. 3 illustrates a side view of a portion of the tine assembly shown in FIG. 2. Here the valve (250) is shown secured to a head end of a tine (210). An advantage of securing the valve on or proximate to the tine is that dosage can be precisely controlled at the tine. A further advantage of securing the valve on or proximate to the tine is that certain fluids, such as ozone, may be used safely. Where a valve is secured proximate to a tine, the valve may provide fluid delivery to a pair of tines. That is to say, each tine of a pair of tines may both be in fluid communication with a common valve.

Each tine pair may be supported by at least one tine foot. A tine foot helps provide fluid communication between a pair of tines from a single valve secured to or integrated with a first port of the tine foot. Optionally, the tine foot includes a further port for providing additives to mix with ozonated water and/or dissolved oxygen in the tines. The additives are provided in a pressurised line. Providing the additives in an entirely separate line is advantageous because it reduces the chances of the ozonated water/dissolved oxygen feed from becoming contaminated by the additives. Typically, the additives comprise flavonoids or any other additive as described elsewhere herein.

Typically for about 7000 square metres about 350 litres of ozonated water and/or dissolved oxygen may be delivered to the ground. This may be achieved, for example, with a tine spacing of approximately 80 mm×20 tines. Metering of the ozonated water and/or dissolved oxygen is controlled by opening and closing the valve (either pilot operated or electronic solenoid valve). Metering of the ozonated water and/or dissolved oxygen may also be controlled by a flow regulator. Optionally, the valve comprises a flow regulator. Optionally, the flow regulator is mechanical or electronic. In some embodiments, a changeover from ozonated water to dissolved oxygen (or vice versa) may be achieved using software, electrical switching or the like.

Where additives are added by a further port on a tine foot, the mixture of additive to ozonated water can be controlled by controlling additive line pressure and valve timing. Additionally or alternatively, a further valve may be provided between the additive line and the further port of the tine foot.

FIG. 4 illustrates an embodiment of a valve of the present invention. The valve (400) illustrated is securable to, or integrated with, a head end region of a tine, such as the tine assembly (200) in FIG. 2. The valve (400) shown is a needle valve, however the valve may be any other type of suitable valve such as a gate valve, butterfly valve, ball valve or check valve.

The valve (400) includes a piston (410) provided within a valve body (415). The piston (410) is biased by a spring (420). The piston (410) has a tip end configured to form a fluid tight seal with the valve body. The spring (420) provides a biasing force to hold the piston (410) in a sealed configuration with the valve body (415). In the view shown in FIG. 4, the piston is moved vertically upwards using a pilot (430) and/or a solenoid (440). Engaging the solenoid (440) urges the piston (410) against the biasing force of the spring (420). This allows the tip end of the piston (410) to release from a sealed configuration with the valve body (415), thereby creating fluid flow path between a fluid inlet (450) and a fluid outlet (455) of the valve. Additionally, or alternatively, a fluid may be provided via the pilot (430) to urge the piston (410) against the spring (420). This may provide redundancy if a solenoid fails or vice versa. The combination of a pilot and a solenoid may also help to control a dose of fluid through the valve. Other electrical, pneumatic or hydraulic mechanisms may be used for actuation of the valve.

To prevent a fluid entering the fluid inlet from interacting with certain elements of the valve, a sealing element (460), such as an O-ring or washer, is provided between an outer surface of the piston (410), near the tip end, and an inner surface of the valve body (415).

Parts of the valve that may be exposed to ozone in use such as the valve body (415), piston (420) and sealing element (460) may be constructed from one or more ozone-resistant materials. An ozone-resistant material is one or a combination of materials that exhibit minimal degradation or wear when exposed to ozone or ozonated fluids for long periods of time, for example several months or years for use in the present invention. The valve body (415), at least internally, and the piston (410) are constructed from stainless steel (304/316 or other grades). The sealing element is made of PTFE or other suitable polymer. Typically, the valve (400) is capable of withstanding 8 bar (g) of pressure. In use, the valve is provided with fluid at around 10-80 psi at the fluid inlet of the valve.

Materials that are suitably ozone-resistant include ABS plastic, Acrylic (Perspex®), Aluminium, Brass, Bronze, Butyl, Chemraz, Copper, CPVC, Cross-linked Polyethylene (PEX), Durachlor-51, EPDM, EPR, Ethylene-Propylene, Flexelene, Fluorosilicone, Glass, Hastelloy-C®, HDPE, Inconel, Kalrez, Kel-FR (PCTFE), LDPE, PEEK, Polyacrylate, Polycarbonate, Polyethylene, Polysulfide, millable Polyurethane, PTFE, PVC, PVDF (Kynar®), Santoprene, Silicone, Stainless Steel (304/316 or other grades), Titanium, Tygon, Vamac and Viton. This list is not exhaustive.

FIG. 5 illustrates further components (500) of a tine delivery system for delivering ozonated water to ground. The system includes a tank (510), including a breather valve (514) and an ozone knockout (518). The ozone knockout is provided to disassociate undissolved ozone exiting the tank (510), such that the gases exiting the tank are safe. The tank is securable to a frame (520). The frame (520) may be securable to a vehicle. At least one crank assembly (not shown in FIG. 5) may be attached to the frame (520). The crank assembly(s) include at least one crank attached to a rotatable crankshaft drivable by a motor. At least one support element may also be attached to the frame (520) for supporting the frame thereby enabling the frame to be moved across ground. The tank is a store of water mixed with ozone. The tank is therefore manufactured from an ozone-resistant material.

A manifold (530) is provided for communicating fluid to and/or from the tank (510). The manifold (530) is also made of an ozone-resistant material. The manifold includes ball valves that can either be manually or electronically actuated and can be set to produce aeration or spray.

An ozone generator (540) is also provided coupled with or proximate to the tank (510). A programmable logic controller (PLC) or controller (550) is also provided for controlling ozone generation and valve actuation. Alternatively, ozone generation and fluid delivery are computer controlled.

A generator (560) for powering the PLC (550), pumps (580) and ozone generator is also provided. Alternatively, the components illustrated in FIG. 5 may be powered by a battery.

A washdown tank (570) is also illustrated.

One or more pumps (580) may also be provided to deliver ozonated water to a valve such as the valve (400) illustrated in FIG. 4, which is provided in the tine assembly (200) shown in FIG. 2. The pump (580) shown is controlled by the PLC (550) or a computer to maintain a consistent fluid pressure to the valves and tines. The pump is constructed of suitable ozone-resistant materials.

For operation of the tine delivery system of the present invention, the tank (510) is filled with water having the correct pH value (e.g. in the region of 6-7). Once the desired level of water is achieved the ozone generator (540) can be started.

To generate ozone, atmospheric oxygen is taken into an oxygen concentrator (not shown) that removes nitrogen and moisture. This allows an oxygen supply of 80% and above to be provided to the ozone generator (540). Dielectric Barrier Discharge (corona discharge), UV Radiation and Electrolytic Ozone Generation are three methods typically used to generate ozone. The ozone generator (540) applies a corona discharge method to separate diatomic oxygen, which recombines to form triatomic oxygen, known as ozone. More specifically, inside the ozone generator, ozone is produced from oxygen present in the feed gas by means of a spark known as intense corona in some cases. This is produced by forcing a high voltage source through a dielectric and small air gap. This is typically called a corona cell. This is achieved by a control circuit board and transformer. The oxygen feed, whether produced by an oxygenator or introduced via an oxygen cylinder, is forced through the small air gap along the dielectric and intense corona. This is the process which splits the oxygen molecules and generates the ozone. The oxygen feed gas flow and the pressure necessary for continued ozone production and concentration can be adjusted this is either typically achieved by valves or by PLC control.

The water is contained in the tank (510) with a recirculating pump. As the water is recirculated, a suction is created by a venturi. The venturi sucks ozone gas into the recirculating water, mixing gaseous ozone into the water. Around 70% of the gas produced from the ozone generator (540) is mixed into the water. Alternative methods include, for example, nano-bubble methods or the like.

Ozone is an unstable gas and converts back to oxygen. For this reason, ozone must be constantly generated. The PLC (550), or ozone controller, is used to measure the ozone level in the water and maintain the ozone concentration at the desired set level. Any undissolved ozone & oxygen can exit the water storage tank (510) via the breather valve (514) before going through the ozone knockout (518), which will remove the concentration of ozone gas from the gas exiting the tank.

Components of the ozone generator include an incoming compressed air pressure regulator, ozone flow control needle valve, oxygen pressure gauge, dissolved ozone monitoring or PLC controller, ozone production indication device, variable output valve, ozone generation cell, air pressure regulators and coalescing filters, oxygen concentrator, automated solenoid bolt valves, 12/24 Volt DC inverter or link to power generation method.

A bioflavonoid and/or any other liquid as described herein can be dosed directly into the mixing tank or via the water line according to the required amount needed.

Depth of penetration is infinitely variable and is controlled by a screw mechanism on a full width roller mounted forward of the tines.

For a pilot operated valve (400), the valve is actuated by compressed air. A compressed air line is provided separate to the ozonated water line. The air operating the valve is at 4 bar (g) and controlled by a lever valve located on a cam attached to a main shaft of the tine delivery system.

For a solenoid operated valve (400), the valve is actuated by an electrical solenoid (440). A signal is provided via an output of the PLC (550) to the solenoid. The signal is sent via a proximity sensor located on the cam attached to the main shaft of the tine delivery system.

The injection timing is such that the dissolved ozonated water mix is injected into the ground through tine outlet apertures when the tines reach an extreme extent of their travel into the ground. The depth of insertion of the tines can be around 450 millimetres or more.

In addition to the dissolved ozone water mix being routed to the tines, the same mix can be routed via a common manifold and directed to a spray boom (not shown). This allows the same mix to be sprayed over the turf grass surface.

When ozone is dissolved in water it has substantially the same oxidising power as gaseous ozone. Ozone has a short half-life in water which depends on the water temperature, pH and the contaminants present.

Ozonated water may be used on its own. Ozonated water can also be combined with hydrogen peroxide (H2O2), ultraviolet light, or other compounds to perform an advanced oxidation process.

The Ozone is dissolved into the water via a venturi or nano bubble device in the tank (510). This ozonated water mix is constantly agitated via a pump. The level of ozone required by the operator is maintained continuously using a PLC or programmer device.

Once a predetermined level of ozone is reached then an indication is given and the injection can commence. Alongside the mixing tank is a dose manager, or Dosatron, to provide the injection of a Bioflavonoid and/or Hydrogen Peroxide to the tines or the tank.

This allows further liquid compounds to be injected in a controlled manner to the premixed solution of ozonated water. The premixed water is then distributed to the multiple tines and spray nozzles using ozone compatible materials.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. An apparatus for delivering a metered amount of a liquid composition to the ground, the apparatus comprising:
at least one penetrating element, comprising:
a tip at a first end region of the penetrating element for penetrating ground,
at least one fluid inlet aperture at a further end region of the penetrating element opposite the first end region,
at least one fluid outlet aperture and,
an internal fluid communication passageway extending between the fluid inlet aperture and the fluid outlet aperture; and
at least one valve secured to or integrally formed with or comprising said at least one penetrating element, the valve further comprising:
at least one valve element moveable within a body of the valve to selectively open a fluid flow path between at least one fluid inlet opening of the valve and the fluid outlet aperture.

2. The apparatus claimed in claim 1, wherein the liquid composition is ozonated water and/or dissolved oxygen.

3. The apparatus of claim 1, wherein one or more surfaces of the fluid flow path are ozone resistant.

4. The apparatus as claimed in claim 2,
wherein the valve body, valve element and penetrating element are manufactured from one or more ozone-resistant materials and optionally
wherein the ozone-resistant materials are selected from the list of: PEEK, PVC, CPVC, Butyl, Chemraz, Cross-Linked Polyethylene (PEX), Durachlor-51, EPR, Ethylene-Propylene, Fluorosilicone, Glass, Hastelloy-C®, HDPE, Inconel, Kalrez, PCTFE, millable Polyurethane, PVDF, Santoprene, Silicone, Stainless Steel-304/316, PTFE, Titanium, Vamac, Viton, Polycarbonate.

5. (canceled)

6. The apparatus as claimed in claim 1, wherein:
(i) the at least one valve is secured proximate to the penetrating element(s); and/or
(ii) the valve further comprises at least one actuating element comprising at least one pilot and/or at least one solenoid, optionally wherein the solenoid is adapted to move the valve element between a closed position and an open position; and/or
(iii) the valve further comprises an actuation time in the range of at least about 20 to 200 ms, about 200 to 500 ms or about 0.5 to 1 s and/or
(iv) the penetrating element comprises a plurality of substantially parallel tine elements, optionally wherein each tine element is secured proximate to, or integrally formed with, a valve or wherein two or more tine elements are secured proximate to, or integrally formed with a valve; and/or
(v) the plurality of tine elements comprises two substantially parallel tine elements spaced apart by a distance of between about 25 to 160 mm.

7. (canceled)

8. The apparatus as claimed in claim 1, further comprising at least one connector member that secures the further end of the penetrating element to the valve, wherein:
(i) the connector member is a common connector member securing each of the plurality of tine elements to at least one respective valve; and/or
(ii) the connector member is a common connector member securing each of two tine elements to a respective valve; and/or
(iii) the connector member secures a distal end of a tine element to an outlet member of the valve optionally wherein the end of the tine element and the outlet member are secured in a sealing engagement.

9. The apparatus as claimed in claim 8, further comprising:
a connecting arm comprising an elongate arm element secured to the connector member at a first end of the arm element and to a ring-shaped element at a further end of the arm element, the ring-shaped element being connectable to a crank, wherein the connecting arm extends away from the connector member in a direction substantially opposite to the tine element.

10. The apparatus as claimed in claim 1, wherein:
(i) each tine element comprises at least one tine fluid outlet disposed on at least one side wall extending between a tip end and a distal end of each tine element; and/or
(ii) each tine element comprises two tine fluid outlets disposed at opposing locations on the side wall; and/or
(iii) the at least one side wall is an annular side wall; and/or
(iv) the tine fluid outlet is spaced a distance of about 1 millimetre to about 50 millimetres from the tip of the tine element; and/or
(v) a diameter of tine fluid outlet is in the range of about 6 mm to about 25 mm; and/or
(vi) a diameter of the internal fluid communication passageway is in the range of about 2.5 to about 23 mm; and/or
(vii) when the fluid flow path is selectively opened, a metered amount of ozonated water and/or dissolved oxygen in the range of about 2 to about 100 gallons per hour is able to flow through the tine fluid outlet; and/or
(viii) the tine fluid inlet and valve fluid outlet are separated by a distance of up to about 5 to about 25 mm.

11. A ground injection system for delivering a metered amount of a liquid composition to the ground, the system comprising:
a frame;
at least one crank assembly attached to the frame, the crank assembly(s) comprising at least one crank attached to a rotatable crankshaft drivable by a motor;
at least one tine assembly, comprising the apparatus as claimed in any preceding claim, each attached to at least one crank of the crank assembly such that the tip of a penetrating element points towards the ground; and
at least one fluid delivery conduit for delivering the liquid composition to a valve of a respective tine assembly.

12. The system as claimed in claim 11, wherein the liquid composition is ozonated water and/or dissolved oxygen and a portion of the fluid delivery conduit that defines a fluid flow path through the conduit is manufactured from one or more ozone-resistant materials.

13. The system as claimed in claim 11, further comprising:
(i) the tine assembly being reciprocally moveable by the crank in a direction substantially parallel to a central longitudinal axis of the tine elements; and/or
(ii) a holding vessel for storing dissolved oxygen and/or ozonated water that is connected to the fluid delivery conduit; and/or
(iii) an ozone generator that is adapted to generate gaseous ozone and a further fluid delivery conduit adapted to deliver the gaseous ozone to the holding vessel for ozonating water; and/or
(iv) a source of compressed air in fluid communication with the holding vessel, the compressed air being selectively providable to the ozonated water at predefined intervals to agitate the ozonated water and/or provide dissolved oxygen to the water.

14. The system as claimed in claim 11, wherein:
(i) each tine assembly is attached to a respective crank; and/or
(ii) each tine assembly is attached to a crank via a pivot arm; and/or
(iii) the system further comprises a plurality of tine assemblies and a plurality of crank assemblies, each crank assembly comprising two cranks sharing a common rotatable crankshaft, and each crank attached to a respective tine assembly.

15. The system as claimed in claim 11:
(i) further comprising at least one link arm attached to the frame and a respective tine assembly adapted to maintain reciprocal movement of the tine assembly in a direction substantially parallel to a central longitudinal axis of the tine element; and/or
(ii) further comprising at least one support element attached to the frame for supporting the frame thereby enabling the frame to be moved across ground; and/or
(iii) wherein each rotatable crankshaft is drivable by a common motor; and/or
(iv) further comprising a tow bar attached to the frame connectable to a vehicle for moving the ground injection system across ground; and/or
(v) wherein the system is portable.

16. (canceled)

17. (canceled)

18. (canceled)

19. The system as claimed in claim 11, further comprising:
at least one programmable logic controller configured to control operation of a solenoid in the valve assembly adapted to move the valve member between its open and closed positions.

20. A method of delivering a metered amount of a liquid composition to the ground, the method comprising:
providing at least one penetrating element comprising a tip at a first end for penetrating the ground and at least one fluid outlet aperture;
inserting the penetrating element into ground; and
when the penetrating element is in the ground, selectively opening a fluid flow path between a fluid inlet of at least one valve and the fluid outlet aperture, thereby delivering a metered amount of the liquid composition to the ground and optionally wherein the liquid composition is ozonated water and/or dissolved oxygen.

21. The method of claim 20, further comprising:
providing the at least one valve secured to or integrally formed with or comprising the penetrating element; and/or
providing the liquid composition to at least one fluid inlet of the valve; and/or
rotating a crankshaft to cause reciprocal movement of at least one crank attached to the crankshaft such that the penetrating element that is attached to the crank repeatedly enters and withdraws from the ground; and
each time the penetrating element is in the ground, selectively opening a fluid flow path between the fluid inlet of the valve and the fluid outlet aperture of the penetrating element, thereby delivering a metered amount of the liquid composition to the ground.

22. (canceled)

23. The method as claimed in claim 21, further comprising:
providing an ozone generator adapted to generate gaseous ozone; and/or
providing gaseous ozone to a holding vessel for ozonating water stored in the holding vessel.

24. The method as claimed in claim 21, wherein the method is a method of delivering a metered amount of ozonated water and/or dissolved oxygen to:
(i) soil of a grass lawn and/or hybrid grass lawn and/or agricultural field and/or horticultural field; or
(ii) soil of a playing surface, including a sports pitch and/or a playing field.

25. The method as claimed in claim 21, wherein the ozonated water comprises ozonated water and one or more additives selected from a liquid fertiliser, nematicide, fungicide, wetting agent, soil conditioner, flavonoid, biostimulant or insecticide (e.g., acelepryn) and optionally wherein the additives comprise one or more flavonoid(s).

26. (canceled)

27. The apparatus of claim 1, wherein, during delivery to the ground, the liquid composition is interchangeable from ozonated water to dissolved oxygen.
